(19) United States
(12) Patent Application Publication
(10) Pub. No.: US 2019/0143232 A1
(43) Pub. Date: May 16, 2019

(54) DRAG-REDUCING SYSTEMS AND CHARGING SYSTEMS FOR ELECTRIC SCOOTER

(71) Applicant: BRAVO SPORTS, Santa Fe Springs, CA (US)

(72) Inventors: Jack B. Lovley, II, Lake Forest, CA (US); Kenneth Edlauer, Newbury Park, CA (US); Mark Groenhuyzen, Huntington Beach, CA (US)

(21) Appl. No.: 16/007,121

(22) Filed: Jun. 13, 2018

Related U.S. Application Data
(60) Provisional application No. 62/519,097, filed on Jun. 13, 2017.

(51) Int. Cl. A63H 17/26; B62M 6/45; B62K 5/027

(52) U.S. Cl. CPC A63H 17/262; B62K 5/027; B62M 6/45

(57) ABSTRACT

An electric vehicle or toy having a drag reducing system to allow the electric vehicle or toy to facilitate manual or unpowered operation. The electric vehicle or toy can include a mode-switching system which can switch the electric vehicle or toy between an “electric-operation” mode to a “manual-operation” mode. The “manual-operation” may decouple one or more components of the electric drive system to reduce rolling resistance or drag. The electric vehicle or toy can include one or more one-way bearings which allow components to freely rotate in a desired direction. For example, the one-way bearings can allow the electric vehicle or toy to freely rotate in a forward direction while inhibiting or preventing rotation in a rearward direction.

### CROSS-REFERENCE TO RELATED APPLICATIONS

This application claims the priority benefit under 35 U.S.C. § 119(e) of U.S. Provisional Application No. 62/519,097, filed Jun. 13, 2017, the entirety of which is hereby incorporated by reference herein. Any and all applications identified in a priority claim in the Application Data Sheet, or any correction thereto, are hereby incorporated by reference herein and made a part of the present disclosure.

### BACKGROUND

### Field

Embodiments disclosed herein relate generally to electric vehicles and toys. In particular, certain embodiments relate to electric scooter assemblies, including children's two-wheeled and three-wheeled electric scooter assemblies.

### Background

Many types of scooters exist, including two-wheeled and three-wheeled scooters and electric scooters. Three-wheeled scooters can be advantageous for young children to avoid or lessen the need to balance the scooter. Providing powered movement for a vehicle, such as scooters and other vehicles powered by an electric motor, can also be used to improve the user experience for children. A need exists for improved electric scooters and/or new designs to provide the consumer with a useful choice.

### SUMMARY

The systems, methods and devices described herein have innovative aspects, no single one of which is indispensable or solely responsible for their desirable attributes. Without limiting the scope of the claims, some of the advantageous features will now be summarized.

In some embodiments, an electric vehicle or toy can have at least an electric-operation mode and manual-operation mode. The electric vehicle or toy can include a first wheel. The electric vehicle or toy can include a second wheel. The electric vehicle or toy can include a powertrain. The powertrain can include an electric motor. The electric vehicle or toy can include a power source which can provide power to the electric motor. The power source can be removable from the electric vehicle or toy. The electric vehicle or toy can include a mode-switching system which can switch between at least the electric-operation mode and the manual-operation mode. In the electric-operation mode, the electric motor can be operably coupled to at least the first wheel. In the manual-operation mode, the electric motor can be decoupled from at least the first wheel.

In some embodiments, an electric vehicle or toy can have at least an electric-operation mode and manual-operation mode. The electric vehicle or toy can include a first wheel. The electric vehicle or toy can include a second wheel. The electric vehicle or toy can include a powertrain. The powertrain can include an electric motor. The electric vehicle or toy can include a power source which can provide power to the electric motor. The power source can be removable from the electric vehicle or toy. The electric vehicle or toy can include a mode-switching system which can switch between at least the electric-operation mode and the manual-operation mode. The mode-switching system can switch between the modes based at least in part on the position of the power source. In the electric-operation mode, the electric motor can be operably coupled to at least the first wheel. In the manual-operation mode, the electric motor can be decoupled from at least the first wheel.

In some embodiments, an electric vehicle or toy can have at least an electric-operation mode and manual-operation mode. The electric vehicle or toy can be used on a ground surface. The electric vehicle or toy can include a first wheel. The electric vehicle or toy can include second wheel. The electric vehicle or toy can include a powertrain. The powertrain can include an electric motor. The powertrain can be operably coupled to at least the first wheel. The electric vehicle or toy can include a power source which can provide power to the electric motor. The power source can be removable from the electric vehicle or toy. The electric vehicle or toy can include a mode-switching system which can to switch between at least the electric-operation mode and the manual-operation mode. In the electric-operation mode, at least the first wheel can contact the ground surface. In the manual-operation mode, at least the first wheel can retract away from the ground surface.

In some embodiments, an electric vehicle or toy can include a first wheel. The electric vehicle or toy can include a powertrain. The powertrain can include an electric motor. The powertrain can be operably coupled to at least the first wheel. The electric vehicle or toy can include a power source which can provide power to the electric motor. The power source can be removable from the electric vehicle or toy. The electric vehicle or toy can include a one-way bearing.

In some embodiments, an electric vehicle or toy can have an on-board charging system. The electric vehicle or toy can include a first wheel. The electric vehicle or toy can include a second wheel. The electric vehicle or toy can include an electronics system. The electronics system can include an electric motor. The electronics system can include a power source which can provide power to the electric motor. The electronics system can include a port which can receive a first electronic current. The electronics system can include a circuit which can to convert the first electronic current to a second electronic current. The second electronic current can be directed to the power source.

### BRIEF DESCRIPTION OF THE DRAWINGS

These and other features, aspects and advantages are described below with reference to the drawings, which are intended to illustrate embodiments of electric vehicles, such as two-wheeled and three-wheeled scooters, as well as embodiments of various components of these electric vehicles.

FIG. 1 is a perspective view of an embodiment of a scooter assembly.

FIG. 2 is a top perspective view of an embodiment of an electric motor and transmission system for a scooter assembly.

FIG. 3 is a top plan view of an embodiment of an electric motor and transmission system for a scooter assembly.

FIG. 4 is a right side elevational view of an embodiment of an electric motor and transmission system for a scooter assembly.

FIG. 5 is a left side elevational view of an embodiment of an electric motor and transmission system for a scooter assembly.

FIG. 6 is a bottom perspective view of an embodiment of a scooter assembly having an electric motor and transmission system.

FIG. 7A is a schematic of an embodiment of a scooter assembly having an electric motor, transmission system, and mode-switching system between the electric motor and transmission system.

FIG. 7B is a schematic of an embodiment of a scooter assembly having an electric motor, transmission system, and mode-switching system within the transmission system.

FIG. 7C is a schematic of an embodiment of a scooter assembly having an electric motor, transmission system, and mode-switching system between a driven wheel and the transmission system.

FIGS. 8A-B are schematics of an embodiment of a scooter assembly having an electric motor, transmission system, and mode-switching system which moves a driven wheel relative to a surface on which the scooter assembly is being used.

FIGS. 9A-B are schematics of an embodiment of a scooter assembly having an electric motor, transmission system, and mode-switching system which moves a powertrain housing.

FIG. 10A is a top perspective view of an embodiment of an electric vehicle having an electric motor, transmission system, and mode-switching system in a first configuration.

FIG. 10B is a top perspective view of the electric vehicle of FIG. 10A with the mode-switching system in a second configuration.

FIG. 11A is a side elevation view of the electric vehicle of FIG. 10A, the mode-switching system in the first configuration.

FIG. 11B is a side elevation view of the electric vehicle of FIG. 10A, the mode-switching system in the second configuration.

FIG. 12A is a top perspective view of the electric vehicle of FIG. 10A with components removed to illustrate underlying components, the mode-switching system in the first configuration.

FIG. 12B is a top perspective view of the electric vehicle of FIG. 10A with components removed to illustrate underlying components, the mode-switching system in the second configuration.

FIG. 13 is a top-oriented schematic of a drive system having an electric motor and transmission system for a scooter assembly.

FIG. 14 is a cross-sectional schematic of the drive system of FIG. 13 along line “A-A”.

FIG. 15 is a cross-sectional schematic of the drive system of FIG. 13 along line “B-B”.

FIG. 16 is a perspective view of an embodiment of a scooter assembly having an on-board charging system.

FIG. 17 is a schematic view of an embodiment of an electronics system for the scooter assembly of FIG. 16.

FIG. 18 is a partial cut-away view of an embodiment of a scooter assembly having an on-board charging system.

FIG. 19 is a perspective view of an embodiment of a port.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the disclosure herein extends beyond the specifically disclosed embodiments, examples and illustrations, and can include other uses and obvious modifications and equivalents thereof. The terminology used in the description presented herein is not intended to be interpreted in any limited or restrictive manner simply because it is being used in conjunction with a detailed description of certain specific embodiments. In addition, embodiments described herein can include several novel features and no single feature is solely responsible for its desirable attributes or is essential.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

While the description sets forth specific details of various embodiments, it is to be appreciated that the description is illustrative only and should not be construed in any way as limiting. Additionally, although particular embodiments may be disclosed or shown in the context of particular types of electric vehicles, such as an electric three-wheeled scooter, it is understood that any elements of the disclosure may be used in any type of electric vehicle or toy including, but not limited to, two-wheeled scooters and trolleys.

Generally, electric vehicles and toys have one or more wheels which are operatively coupled to one or more motors. The one or more wheels can be operatively coupled to the one or more motors directly or indirectly via a transmission. This transmission may include one or more components such as, but not limited to, gears, belts, chains, driveshafts, and/or axles. The motors and/or the transmission can impose an oftentimes significant resistance on the electric vehicle or toy. For example, the motor can impose significant resistance due in part to electromagnetic interactions within the motor. Moreover, in implementations which incorporate a transmission, the various components can impose resistance due in part to friction between the various components.

In the electric vehicle and toy systems described herein, the resistance caused by the motor and/or transmission can be significantly reduced vis-à-vis other (e.g., existing scooter designs). For example, the resistance (e.g., friction) can be reduced by 5% to 50% (e.g., 5-10, 10-20, 20-30, 30-40, 40-50%, percentages between the foregoing, etc.), by 10% to 70%, greater than 70%, etc. relative to equivalent scooters that do not have such a resistance-reducing feature. Among other benefits, this can advantageously permit the user to more easily manually operate the vehicle (e.g., as a push vehicle such as a push scooter) when desired by the user. Among yet other benefits, this can beneficially enhance the overall efficiency of the vehicle or toy thereby increasing the total runtime of the vehicle or toy.

In the electric vehicle and toy systems described herein, structures of the electric vehicle or toy can be moved by the user to modify the amount of drag. For example, as will be described in further detail herein, the electric vehicle or toy can automatically switch to a “manual-power” configuration upon removal of the power source from the electric vehicle or toy. This can advantageously allow the user to continue to manually utilize the electric vehicle or toy, with little to no drag from the motor and/or transmission, while the power source is being charged remotely. Upon replacement of the power source into the electric vehicle or toy, the electric vehicle or toy can automatically switch back to the “electric-power” configuration to allow the user to utilize the motor to operate the electric vehicle or toy.

In the electric vehicle and toy systems described herein, friction reducing components can be utilized to modify the amount of drag. For example, as will be described in further detail below, the electric vehicle or toy can incorporate one or more one-way bearings along the transmission path between the motor and the driven wheel.

### Scooter Embodiment

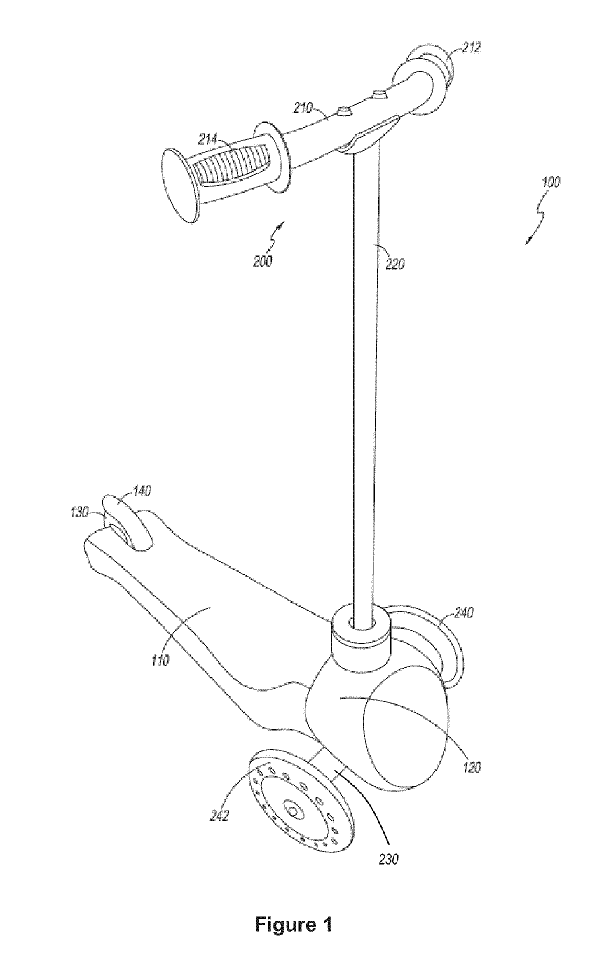

With reference first to FIG. 1, an embodiment of a scooter 100 is illustrated. The scooter 100 can generally include a deck 110, a neck portion 120, a rear wheel 130, a foot brake 140, and a steering assembly 200. The deck 110 is a component of the scooter 100 on which a rider can stand during use. For example, the deck 110 can provide a relatively flat upper surface that is configured to support the weight of at least a child. In other embodiments, the deck 110 can be configured to support the weight of an adolescent or adult. In some embodiments, the scooter 100 includes an electric motor and a transmission.

According to some arrangements, the neck portion 120 is joined to the deck 110 at or near a front end of the deck 110. The neck portion 120 can serve to couple the deck 110 and the steering assembly 200. In some embodiments, the neck portion 120 can be integrally formed with the deck 110 such that the deck 110 and neck portion 120 are a single machined or molded component or a unitary structure formed by any suitable process. The scooter 100 can also include, among other components or items, a housing or cowling that encloses a portion or entirety of the steering assembly 200 and, in some configurations, is positioned in front of the deck 110. The housing can have a portion that extends forward of the front wheels 240, 242.

The steering assembly 200 can include a handlebar 210, steering tube 220, rotating axle assembly 230, left front wheel 240 and right front wheel 242. The steering tube 220 can be coupled to and extend through the neck portion 120. The deck 110, neck portion 120 and steering assembly 200 can comprise one or more materials, including without limitation, any combination of metals, alloys, plastic, elastomeric, carbon fiber, other natural or synthetic materials and/or other materials that impart sufficient structural strength to support the weight of at least a child. At a top portion of the steering tube 220 a handlebar 210 can be attached. The handlebar 210 can include a left handle 212 and a right handle 214 for the rider to grip and steer the scooter 100. Turning the handlebar 210 can cause the steering tube 220 to turn the axle 230 about a steering axis of the scooter 100, thereby turning the front left and right wheels 240 and 242 to steer the scooter 100.

In addition, the handlebar 210 can include a user control, such as a power switch (not shown). A user can activate the power switch to turn on or otherwise activate an electric motor. In several arrangements, the power switch is coupled (e.g., operatively, directly or indirectly, etc.) to a controller which may control the electric motor that drives one or more wheels 130, 240, 242 of the scooter 100. Further embodiments of scooters are described in U.S. Pat. No. 9,592,876, entitled Three-Wheeled Electric Scooter, the entirety of which is incorporated herein by reference herein.

### Solid-Gear Transmission

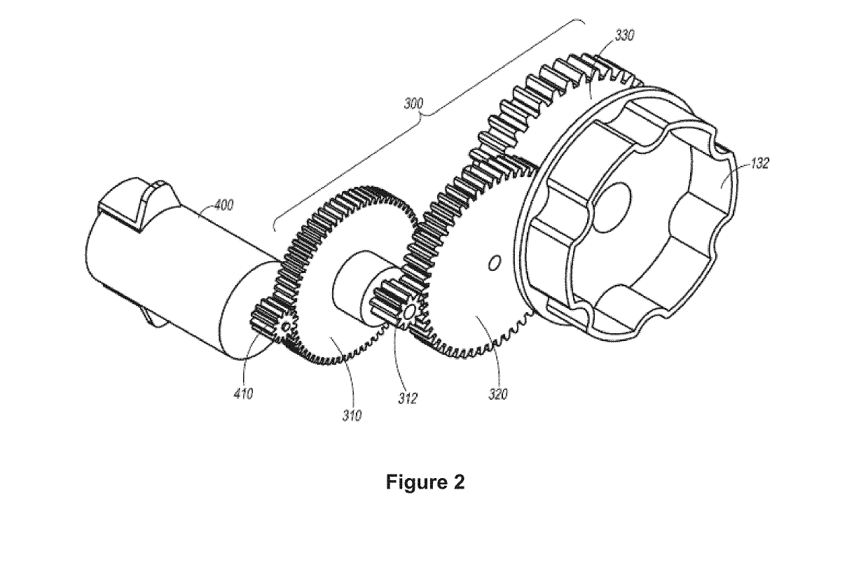

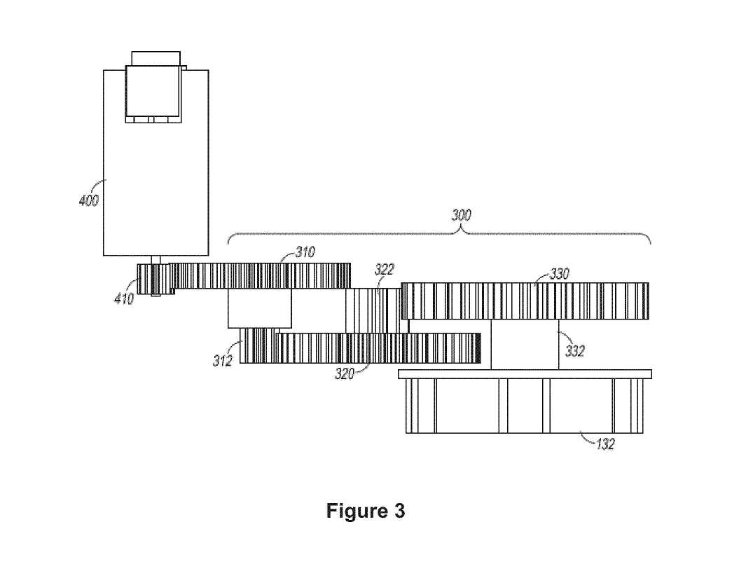

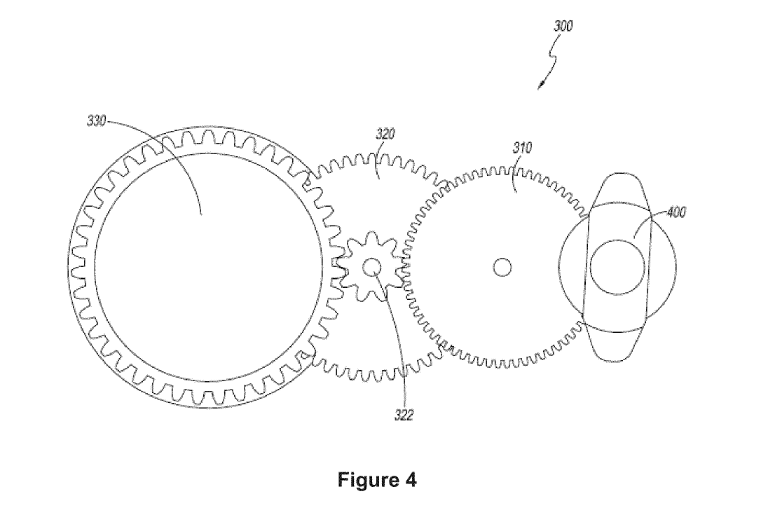

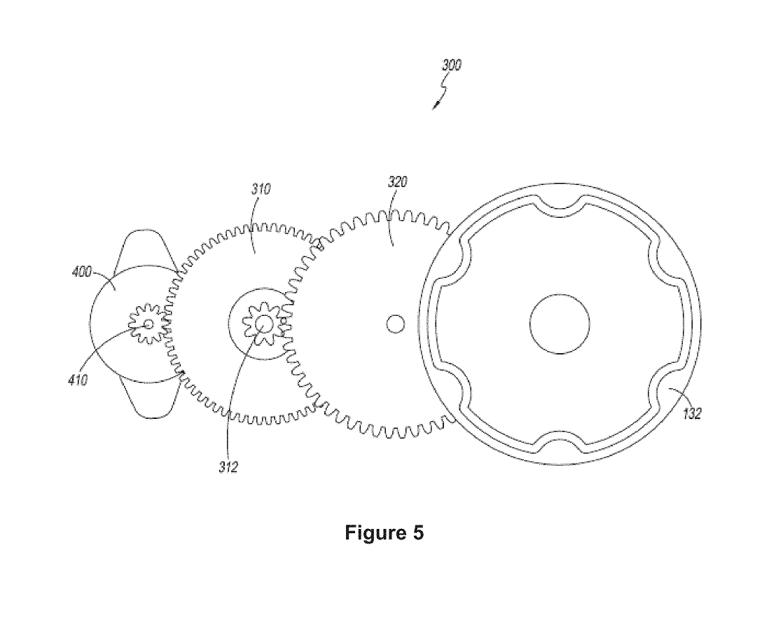

With reference next to FIGS. 2-5, an embodiment of an electric motor and transmission system are illustrated. The electric motor and/or transmission can be positioned underneath the deck 110 or in other suitable locations of a scooter assembly 100. The electric motor and transmission system can generally include an electric motor 400 and a solid-gear transmission 300. For example, the solid-gear transmission 300 can include a first gear 310, a second gear 320, and a third gear 330, which can be spur gears in some configurations. The solid-gear transmission 300 can transfer mechanical power output from the electric motor 400 to the rear wheel of a scooter assembly. The rear wheel 130 of the scooter assembly can be positioned about a rear-wheel casing 132, which serves as a drive element for the rear wheel 130. That is, the casing 132 can be the final drive between the transmission 300 and the rear wheel 130.

In some embodiments, the electric motor can be located on a first side of or relative to the transmission. For example, as illustrated in FIG. 2, if the electric motor 400 is oriented towards the front of a scooter assembly, the electric motor 400 can be located on a right side of the transmission 300. In the depicted embodiment, the body of the motor 400 (excluding the drive shaft to which the gear 410 is coupled) is located to the right of at least a centerline of the transmission, which can be defined as a line equidistant from outermost lateral points of the transmission 300. In some configurations, the outermost lateral points of the transmission 300 fall within opposed lateral planes containing outwardly-facing side surfaces of the gears on each side of the transmission 300. In some configurations, the body of the motor 400 is located to one side of the lateral plane on the same side of the transmission 300.

The rear wheel can be located on a second side relative to the transmission 300, different than or opposite of the first side. For example, if the electric motor 400 is oriented towards the front of a scooter assembly (and on the right side of the transmission 300), the rear-wheel casing 132 can be located on a left side relative to the transmission 300. The relative positioning of the electric motor 400 and rear wheel relative to the transmission can be used to improve the weight distribution of the scooter assembly, which can result in a smoother and more stable ride. In other embodiments, the rear wheel and the electric motor can both be located on a same side relative to the transmission 300. As described, sides of the transmission 300 can be relative to a central line (e.g., right or left of center) of the transmission 300 or relative to outer planes defined by the side surfaces of the outermost gears of the transmission 300.

In some embodiments, the electric motor 400 provides mechanical power to an electric motor shaft 410. For example, when mechanical power is provided to the electric motor shaft 410, the shaft can rotate. The electric motor shaft 410 can include teeth configured to engage teeth of the first gear 310. For example, when the electric motor shaft 410 rotates, rotational energy can be transferred to the first gear 310.

The first gear 310 can impart its rotational energy to a first gear shaft 312. For example, when the first gear 310 rotates, the first gear shaft 312 can rotate at the same rotational speed. The first gear shaft 312 can include teeth configured to engage teeth of the second gear 320. For instance, when the first gear shaft 312 rotates, rotational energy can be transferred to the second gear 320. The second gear 320 can impart its rotational energy to a second gear shaft 322. For example, when the second gear 320 rotates, the second gear shaft 322 can rotate at the same rotational speed. The second gear shaft 322 can include teeth configured to engage teeth of the third gear 330. For example, when the second gear shaft 322 rotates, rotational energy can be transferred to the third gear 330. The third gear 330 can impart its rotational energy to a third gear shaft 332. For example, when the third gear 330 rotates, the third gear shaft 332 can rotate at the same rotational speed. The third gear shaft 332 can be configured to engage a rear wheel. For example, when the third gear shaft 332 rotates, rotational energy can be transferred to the rear wheel 130 via the rear-wheel casing 132.

As described herein, the solid-gear transmission 300 can transfer rotational mechanical energy provided by the electric motor 400 to the rear wheel 130 of the scooter assembly 100. As shown in the illustrated embodiment, the transmission 300 can transfer the mechanical energy via use of gears 310, 320, 330. However, the transmission 300 can include other components, including, but not limited to, drive shafts, belts and/or chains. Although the transmission 300 transfers the mechanical energy provided by the electric motor 400 to the rear wheel 130 of the scooter assembly 100, the transmission 300 can transfer mechanical energy to other wheels of the scooter assembly 100. Further embodiments of transmissions are described in U.S. Pat. No. 9,592,876, entitled Three-Wheeled Electric Scooter, the entirety of which has been incorporated herein by reference.

### Chain-Drive Transmission

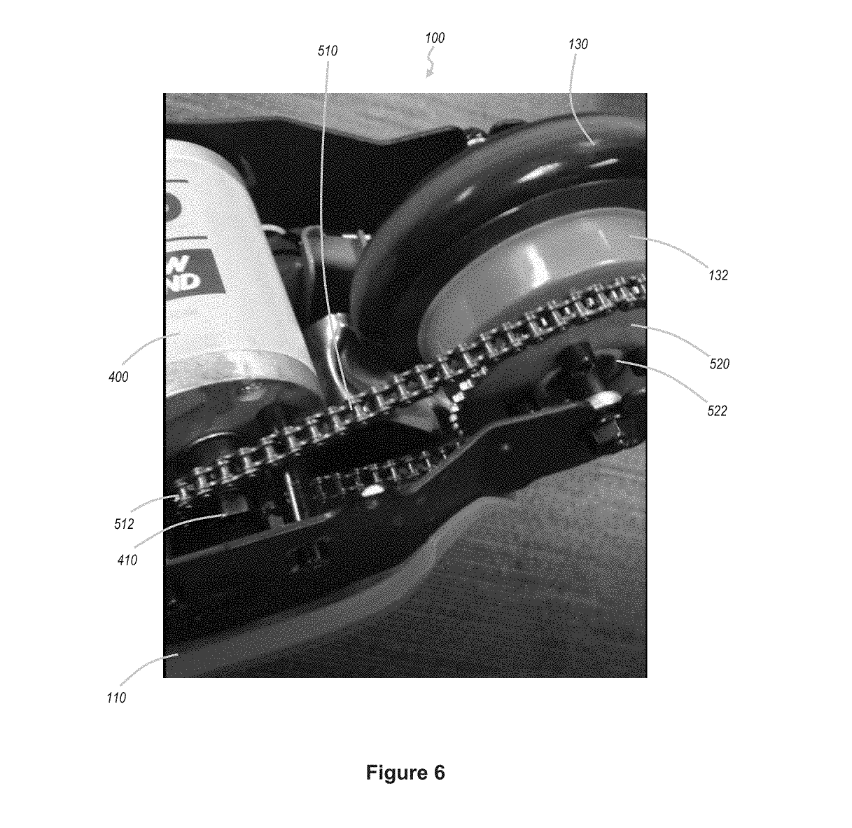

With reference to FIG. 6, an embodiment of an electric motor and transmission system are illustrated. As shown, the electric motor and/or transmission can be positioned underneath the deck 110 or in other suitable locations of a scooter assembly 100. The electric motor and transmission system can generally include an electric motor 400 and a chain-drive transmission 500. For example, the chain-drive transmission 500 can include a chain 510 and a gear 520. The chain-drive transmission 500 can transfer mechanical power output from the electric motor 400 to the rear wheel of a scooter assembly. The rear wheel 130 of the scooter assembly can be positioned about a rear-wheel casing 132, which serves as a drive element for the rear wheel 130. That is, the casing 132 can be the final drive between the transmission 500 and the rear wheel 130.

In some embodiments, the electric motor 400 provides mechanical power to an electric motor shaft 410. For example, when mechanical power is provided to the electric motor shaft 410, it can rotate. The electric motor shaft 410 can include teeth configured to engage links 512 of the chain 510. For instance, when the electric motor shaft 410 rotates, rotational energy can be transferred to the chain 510. The chain 510 can impart its rotational energy to the gear 520. The gear 520 can impart its rotational energy to a gear shaft 522. For example, when the gear 520 rotates, the gear shaft 522 can rotate at the same rotational speed. The gear shaft 522 can be configured to engage a rear wheel. For example, when the gear shaft 522 rotates, rotational energy can be transferred to the rear wheel 130 via the rear-wheel casing 132.

As described above, the chain-drive transmission 500 can transfer rotational mechanical energy provided by the electric motor 400 to the rear wheel 130 of the scooter assembly 100. As shown in the illustrated embodiment, the transmission 300 can transfer the mechanical energy via use of chain 510 and gear 520. However, the transmission 500 can include other components including, but not limited to, drive shafts. Although the transmission 500 transfers the mechanical energy provided by the electric motor 400 to the rear wheel 130 of the scooter assembly 100, the transmission 500 can transfer mechanical energy to other wheels of the scooter assembly 100.

### Mode-Switching Systems

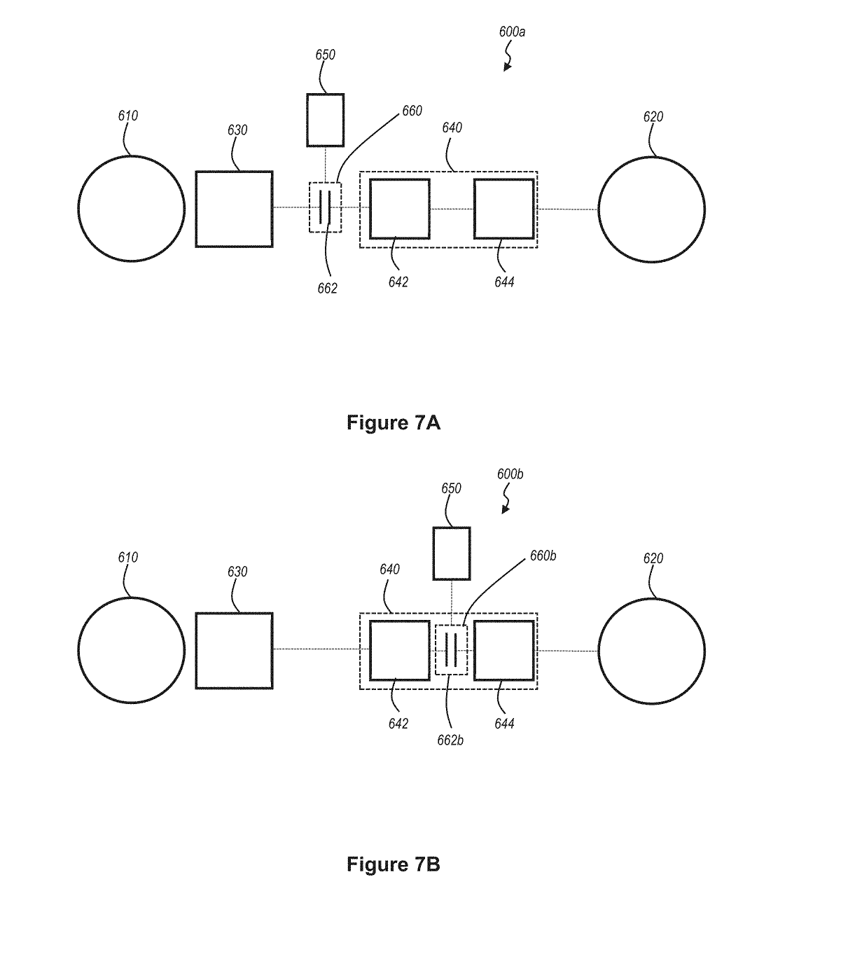

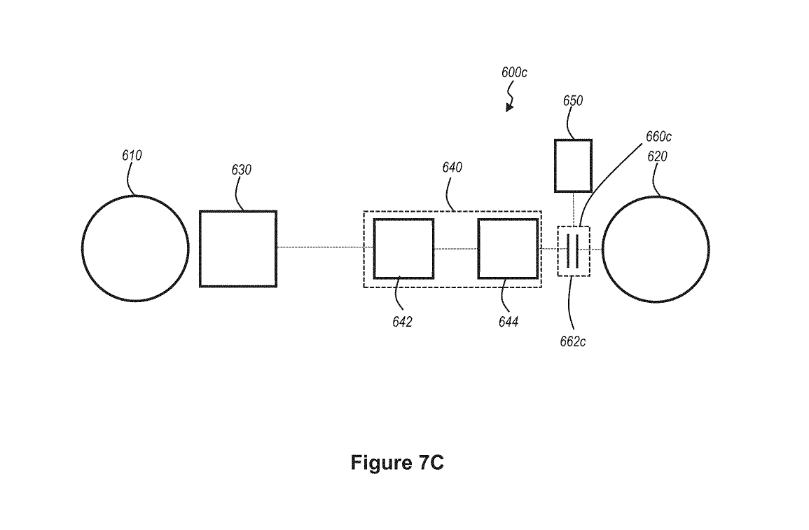

With reference next to FIGS. 7A-12B, embodiments of scooter assemblies 600a-c, 700, 800, 900 are illustrated schematically. The scooter assemblies 600a-c, 700, 800, 900 can be switched between at least two modes—(i) an “electric-power” mode in which the scooter assemblies 600a-c, 700, 800, 900 can be propelled or operated using an electric motor, and (ii) a “manual-power” mode in which the scooter assemblies 600a-c, 700, 800, 900 can be manually propelled or operated with reduced rolling resistance by decoupling at least a portion of the drive system. The scooter assemblies 600a-c, 700, 800, 900 can include movable structures to couple and decouple one or more components of the drive system (i.e., electric motors, transmission system, and driven wheels) to reduce rolling resistance. For example, the scooter assemblies 600a-c can include movable structures to couple and decouple one or more components of the powertrain (e.g., electric motors and transmission system) from the driven wheels. As another non-limiting example, the scooter assemblies 700, 800, 900 can include structures which can move the driven wheels of the drive system into and out of contact with the surface on which the scooter assemblies 700, 800, 900 are being used.

### Mode-Switching Systems having Disengageable Powertrain

With reference first to FIGS. 7A-C, the scooter assemblies 600a-c can include one or more front wheels 610 and one or more rear wheels 620. For example, the scooter assemblies 600a-c can include two front wheels 610 and one rear wheel 620 similar to the three-wheeled scooter 100 described in connection with FIG. 1. The number of wheels can be chosen as desired based on the type of electric vehicle or toy such as, but not limited to, a two-wheeled scooter, a four-wheeled skateboard or trolley, and the like.

In some embodiments, the one or more front wheels 610 are non-driven wheels which are not operably coupled to a motor 630. The one or more rear wheels 620 can be driven wheels which are operatively coupled to one or more motors 630 via a transmission system 640. The transmission system 640 can include one or more transmission components 642, 644 which can transfer rotational mechanical energy provided by the one or more electric motors 640 to the one or more driven wheels 620 of the scooter assemblies 600a-c. The transmission system 640 can include configurations similar to, or the same as, the solid-gear transmission 300 and the chain-drive transmission 500 described above in connection with FIGS. 2-6. For example, the one or more transmission components 642, 644 can include gears, chains, belts, and the like. The scooter assemblies 600a-c can include one or more power sources 650, such as batteries, to power the one or more electric motors 640.

As shown in the illustrated embodiment, the scooter assemblies 600a-c can include movable structures to couple and decouple one or more components of the powertrain (e.g., the one or more motors 630 and the transmission system 640, etc.) from the driven wheels 620. In the “coupled” state, the scooter assemblies 600a-c can take on an “electric-power” configuration such that the user can utilize the one or more motors 630 to power the scooter assemblies 600a-c. In the “decoupled” state, the scooter assemblies 600a-c can take on a “manual-power” configuration.

Such configurations can reduce (e.g., significantly reduce) resistance caused by the one or more motors 630 and/or transmission system 640. For example, the resistance (e.g., friction) can be reduced by 5% to 50% (e.g., 5-10, 10-20, 20-30, 30-40, 40-50%, percentages between the foregoing, etc.), by 10% to 70%, greater than 70%, etc. relative to equivalent scooters that do not have such a resistance-reducing feature. Among other benefits, this can advantageously allow the user to more easily operate the scooter assemblies 600a-c manually (e.g., as a push scooter) when desired by the user. For example, the user may wish to manually operate the scooter assemblies 600a-c when the one or more power sources 650 are depleted. As will be described in further detail below, in some embodiments, switching between the “coupled” and “decoupled” states occurs automatically when the one or more power sources 650 are removed from the scooter assemblies 600a-c.

By way of example, FIGS. 7A-C illustrate various placements of mode-switching systems 660a-c for the scooter assemblies 600a-c which can couple and decouple components of the powertrain (e.g., the one or more motors 630 and transmission 640) from the one or more driven wheels 620.

As shown in FIG. 7A, the mode-switching system 600a can be positioned between the one or more motors 630 and the transmission system 640. For example, the mode-switching system 600a can be positioned between the one or more motors 630 and the first transmission component 642. In some implementations, this can beneficially allow the one or more motors 630 to be more easily removed and serviced by decoupling the one or motors 630 from the transmission system 640.

As shown in FIG. 7B, the mode-switching system 600b can be positioned within the transmission system 640. For example, the mode-switching system 600b can be positioned between the first transmission component 642 and the second transmission component 644. In some implementations, this can beneficially allow the mode-switching system 600b to be contained within the transmission housing which can facilitate servicing and/or replacement of the mode-switching system 600b.

As shown in FIG. 7C, the mode-switching system 600c can be positioned between the one or more driven wheels 620 and the transmission system 640. For example, the mode-switching system 600c can be positioned between the one or more driven wheels 620 and the second transmission component 644. In some implementations, this can beneficially allow for a significant reduction in resistance as the one or more motors 630 and the transmission system 640 can be decoupled from the one or more driven wheels 620. Moreover, this can beneficially reduce wear-and-tear on most powertrain components as these components can remain mostly or completely stationary when the scooter assembly 600c is being utilized in a “manual-power” mode.

Although shown as separate embodiments, it is to be understood that one or more of the mode-switching systems 600a-c can be combined such that a scooter assembly incorporates multiple mode-switching systems 600a-c at different locations within the transmission between the one or more driven wheels 620 and the one or more motors 630.

The mode-switching systems 660a-c can include one or more components which move structures of the scooter assemblies 600a-c relative to each other to decouple these structures from each other. For example, the mode-switching systems 660a-c can include one or more actuators 662a-c which can be actuated to move components of the scooter assemblies 600a-c relative to each other. In some embodiments, the one or more actuators 662a-c can move gears relative to each other such that the gears are meshed in the “coupled” state and the gears no longer meshed in the “decoupled” state. For example, the gears can slide relative to each other. In some embodiments, the one or more actuators 662a-c can be attached to clutches which are attached to gears or shafts of the powertrain. The clutches can be engaged in the “coupled” state and disengaged in the “decoupled” state.

With continued reference to FIGS. 7A-C, the mode-switching systems 660a-c can be operatively coupled to the one or more power supplies 650. In some implementations, the mode-switching systems 660a-c can switch to the “decoupled’ state when the one or more power supplies 650 are removed from the scooter assemblies 600a-c. Thus, the scooter assemblies 600a-c can automatically switch to a “manual-power” mode upon removal of the one or more power sources 650. This can advantageously allow the user to continue to manually operate the scooter assemblies 600a-c, with little (e.g., less relative to embodiments that do not or would not include such features) to no resistance from the one or more motors 630 and/or transmission systems 640, while the one or more power sources 650 are being charged remotely. Moreover, this can advantageously reduce wear-and-tear on powertrain components of the scooter assemblies 600a-c when the scooter assemblies 600a-c are being used in a “manual-power” mode.

In some embodiments, the mode-switching systems 660a-c can include a linkage or hydraulic system which operates the one or more actuators 662a-c. The linkage or hydraulic system can be mechanically operated via positioning of the one or more power supplies 650. For example, the linkage or hydraulic system can transition the one or more actuators 662a-c to the “decoupled” state when the one or more power supplies 650 are removed from the scooter assemblies 600a-c. In some embodiments, the linkage or hydraulic system can be electronically actuated. For example, the scooter assemblies 600a-c can include a controller which can detect removal of the one or more power sources 650 from the scooter assemblies 600a-c. Upon detection of removal, the controller can operate the linkage or hydraulic system to transition the one or more actuators 662a-c to the “decoupled” state. For example, the controller can operate a motor coupled to the linkage or hydraulic system.

In some implementations, the mode-switching systems 660a-c can switch back to the “coupled” state when the one or more power supplies 650 are replaced into the scooter assemblies 600a-c. The scooter assemblies 600a-c can thereby automatically switch back to an “electric-power” mode upon replacement of the one or more power sources 650 to allow the user to utilize the one or more motors 630 to operate the scooter assemblies 600a-c. The linkage or hydraulic system can be mechanically operated via positioning of the one or more power supplies 650. For example, the linkage or hydraulic system can transition the one or more actuators 662a-c to the “coupled” state when the one or more power supplies 650 are replaced into the scooter assemblies 600a-c. In some embodiments, the linkage or hydraulic system is electronically actuated. For example, the scooter assemblies 600a-c can include a controller which can detect replacement of the one or more power sources 650 into the scooter assemblies 600a-c. Upon detection of replacement, the controller can operate the linkage or hydraulic system to transition the one or more actuators 662a-c to the “coupled” state. For example, the controller can operate a motor coupled to the linkage or hydraulic system.

This automatic switching between the “decoupled” and “coupled” state can facilitate operation of the scooter assemblies 600a-c by the user. However, it is to be understood that, in some embodiments, switching between the “decoupled” and “coupled” state is performed manually by the user when the one or more power sources 650 remain in the scooter assemblies 600a-c. For example, the linkage or hydraulic system can be operated by the user via a control such as, but not limited to, a lever, a knob, or a button mechanically or electronically coupled to the linkage or hydraulic system. In some arrangements, this can beneficially allow the user to manually operate the scooter assemblies 600a-c with reduced resistance while the one or more power sources 650 remain in the scooter assemblies 600a-c. For instance, the user may wish to manually operate the scooter assemblies 600a-c when the one or more power sources 650 have been depleted or if the user simply wants to conserve runtime of the power sources 650. In some embodiments, the mode-switching systems 660a-c remain in the “decoupled” state until the one or more power sources 650 have been replaced. This can advantageously reduce wear-and-tear on powertrain components of the scooter assemblies 600a-c when the scooter assemblies 600a-c are unable to be used in an “electric-power” mode (e.g., when the one or more power sources 650 have been removed).

Although actuators 662a-c, linkages, and hydraulic systems have been described in the embodiments above, one or more of these components can be omitted or substituted, as desired or required. For example, in some embodiments, the linkages and/or hydraulic systems can be omitted from the mode-switching systems 660a-c. In such embodiments, the one or more power sources 650 can directly contact and operate the actuators 662a-c. As another example, in some embodiments, actuators 662a-c, linkages, and hydraulic systems can be omitted from the mode-switching systems 660a-c. In such embodiments, the one or more power sources 650 can directly manipulate one or more components of the powertrain (e.g., the one or more motors 630 and/or the transmission system 640). For example, the one or more power sources 650 can contact a gear of the transmission system to move it into and/or out of mesh with another gear of the transmission system. For example, the gears can slide relative to each other.

### Mode-Switching System having Disengageable Driven Wheels

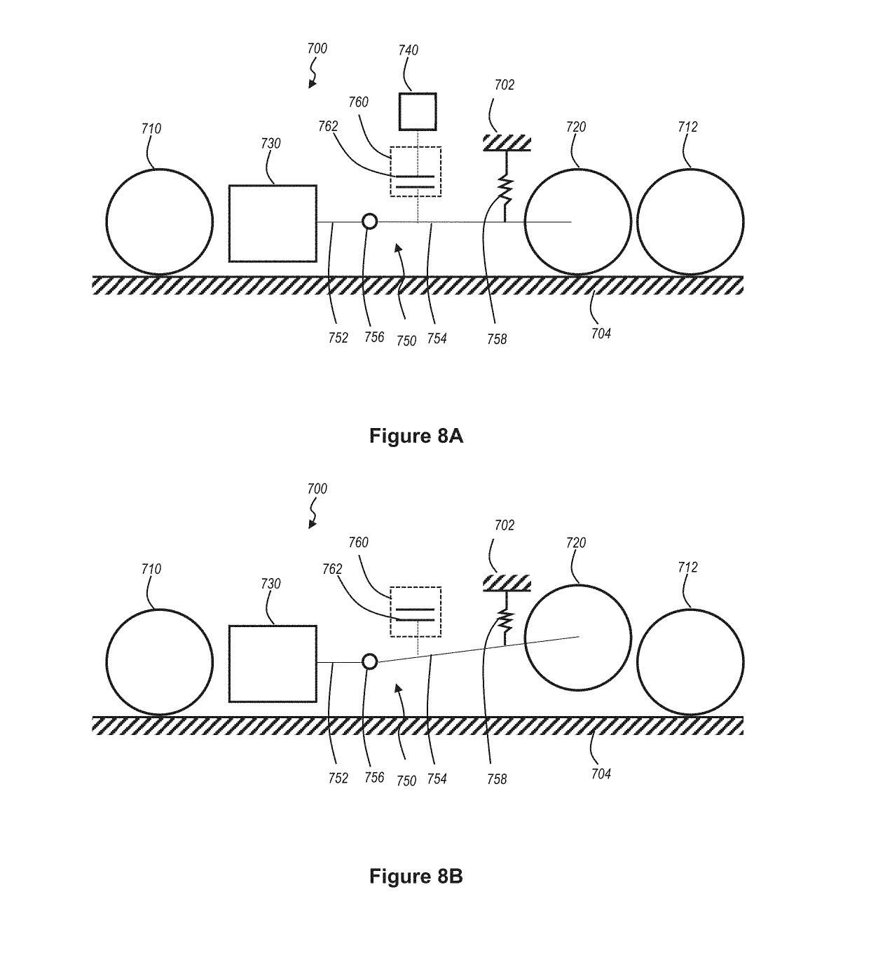

With reference to FIGS. 8A-B, the scooter assembly 700 can include a chassis, a portion 702 of which is illustrated. The chassis can include structures and features which are similar to, or the same as, those of scooter 100 described in connection with FIG. 1. In some embodiments, the chassis 702 can include a deck, a neck portion, and/or a housing for internal components. For reference, a surface 704 on which the scooter assembly 700 can be used is also shown.

The scooter assembly 700 can include one or more non-driven wheels 710, 712 which can be positioned along the front and rear of the scooter assembly 700 respectively. The scooter assembly 700 can include one or more driven wheels 720. Although the one or more driven wheels 720 are shown between the front non-driven wheel 710 and rear non-driven wheel 712, it is to be understood that the driven wheel can be positioned forward of both non-driven wheels 710, 712, rearward of both non-driven wheels 710, 712, and/or in line with the front non-driven wheel 710 and/or rear non-driven wheel 712, as desired or required in a particular configuration. Moreover, the number of wheels can be chosen as desired based on the type of electric vehicle or toy such as, but not limited to, a two-wheeled scooter, a four-wheeled skateboard or trolley, and the like.

The one or more driven wheels 720 can be operatively coupled to a powertrain 730 that can be configured to provide power to operate the one or more driven wheels 720. The powertrain 730 can include structures and features similar to those of the embodiments described in connection with FIGS. 2-7C. For example, the powertrain 730 can include one or more motors (not shown) and/or a transmission system (not shown). In some embodiments, the transmission system can include structures and features similar to, or the same as, those described in connection with the solid-gear transmission 300 and/or the chain-drive transmission 500 described in connection with FIGS. 2-6. The scooter assembly 700 can include one or more power sources 740, such as batteries, to provide energy for the powertrain 730.

With continued reference to FIGS. 8A-B, the scooter assembly 700 can include movable structures to couple and decouple the one or more driven wheels 720 with the surface 704 on which the scooter assembly 700 is being used. In the “coupled” state, the scooter assembly 700 can take on an “electric-power” configuration such that the user can utilize the one or more motors of the powertrain 730 to power the scooter assembly 700. In the “decoupled” state, the scooter assembly 700 can take on a “manual-power” configuration. This can significantly reduce resistance caused by the drive system (i.e., powertrain 730 and one or more driven wheels 720). As is described in further detail below, in some embodiments, switching between the “coupled” and “decoupled” states occurs automatically when the one or more power sources 740 are removed from the scooter assembly 700.

As shown, the powertrain 730 can be operatively coupled to the one or more driven wheels 720 via a transfer assembly 750. The transfer assembly 750 can include two or more shafts 752, 754 which can be moved relative to each other. For example, as shown, the shafts 752, 754 can be coupled together via a rotatable coupling 756 such as, but not limited to, a universal joint such that the angle between the shafts 752, 754 can be changed. Other types of coupling can be used. In some embodiments, the shafts 752, 754 can be coupled together via a coupling (not shown) which allows the shafts 752, 754 to be translated relative to each other. For example, the coupling can include a belt or chain with a movable tensioner pulley.

The shaft 754 can be coupled to a portion of the chassis 702 via a biasing mechanism 758 such as a spring or other resilient member, component or feature. In this manner, using the biasing mechanism 758, the shaft 754 and the one or more driven wheels 720 can be biased in a direction away from the surface 704. The shaft 754 can also be coupled to a mode-switching system 760 having one or more actuators 762.

According to some embodiments, in a “coupled” state as shown in FIG. 8A, the one or more actuators 762 can apply a force on shaft 754 which opposes that of the biasing mechanism 758. This can bring the one or more driven wheels 720 into contact with surface 704 such that the one or more driven wheels 720 can be used to propel the scooter assembly 700. In a “decoupled” state as shown in FIG. 8B, the one or more actuators 762 can apply a lesser force, or no force at all, on shaft 754 thereby allowing the biasing mechanism 758 to pull the shaft 754 upwards towards the portion 702 of the chassis. This can pull the one or more driven wheels 720 out of contact with surface 704 thereby eliminating, or at least significantly reducing, resistance which would typically be caused by the one or more driven wheels 720 and components of the powertrain 730.

As shown in the illustrated embodiment, the mode-switching system 760 can be operatively coupled to the one or more power supplies 740. In some implementations, the mode-switching system 760 can switch to the “decoupled” state as shown in FIG. 8B when the one or more power supplies 740 are removed from the scooter assembly 700. The scooter assembly 700 can thereby automatically switch to a “manual-power” mode upon removal of the one or more power sources 740.

In some embodiments, the mode-switching system 760 can include a linkage or hydraulic system which operates the one or more actuators 762. The linkage or hydraulic system can be mechanically operated via positioning of the one or more power supplies 740. For example, the linkage or hydraulic system can transition the one or more actuators 762 to the “decoupled” state when the one or more power supplies 740 are removed from the scooter assembly 700. In some embodiments, the linkage or hydraulic system can be electronically actuated. For example, the scooter assembly 700 can include a controller which can detect removal of the one or more power sources 740 from the scooter assembly 700. Upon detection of removal, the controller can operate the linkage or hydraulic system to transition the one or more actuators 762 to the “decoupled” state. For example, the controller can operate a motor coupled to the linkage or hydraulic system.

In some implementations, the mode-switching system 760 can switch back to the “coupled” state as shown in FIG. 8A when the one or more power supplies 740 are replaced into the scooter assembly 700. The scooter assembly 700 can thereby automatically switch back to an “electric-power” mode upon replacement of the one or more power sources 740 to allow the user to utilize the powertrain 730 to operate the scooter assembly 700. The linkage or hydraulic system can be mechanically operated via positioning of the one or more power supplies 740. For example, the linkage or hydraulic system can transition the one or more actuators 762 to the “coupled” state when the one or more power supplies 740 are replaced into the scooter assembly 700. In some embodiments, the linkage or hydraulic system can be electronically actuated. For example, the scooter assembly 700 can include a controller which can detect replacement of the one or more power sources 740 into the scooter assembly 700. Upon detection of replacement, the controller can operate the linkage or hydraulic system to transition the one or more actuators 762 to the “coupled” state. For example, the controller can operate a motor coupled to the linkage or hydraulic system.

This automatic switching between the “decoupled” and “coupled” state can facilitate operation of the scooter assembly 700 by the user. However, in some embodiments, switching between the “decoupled” and “coupled” state can be performed manually by the user when the one or more power sources 740 remain in the scooter assembly 700. For example, the linkage or hydraulic system can be operated by the user via a control such as, but not limited to, a lever, a knob, button, switch or other controller mechanically or electronically coupled to the linkage or hydraulic system. This can beneficially allow the user to manually operate the scooter assembly 700 with reduced resistance while the one or more power sources 740 remain in the scooter assembly 700. For example, the user may wish to manually operate the scooter assembly 700 when the one or more power sources 740 have been depleted or if the user simply wants to conserve runtime of the power sources 740. In some embodiments, the mode-switching system 760 remains in the “decoupled” state until the one or more power sources 740 have been replaced.

Although actuators 762, linkages, and hydraulic systems have been described in the embodiments above, it is to be understood that one or more of these components can be omitted. For example, in some embodiments, the linkages and/or hydraulic systems can be omitted from the mode-switching systems 760. In such embodiments, the one or more power sources 750 can directly contact and operate the actuators 762. As another example, in some embodiments, actuators 762, linkages, and hydraulic systems can be omitted from the mode-switching systems 760. In such embodiments, the one or more power sources 750 can directly manipulate one or more components of the powertrain (e.g., the one or more motors and/or the transmission system). For example, the one or more power sources 750 can contact a gear of the transmission system to move it into and/or out of mesh with another gear of the transmission system.

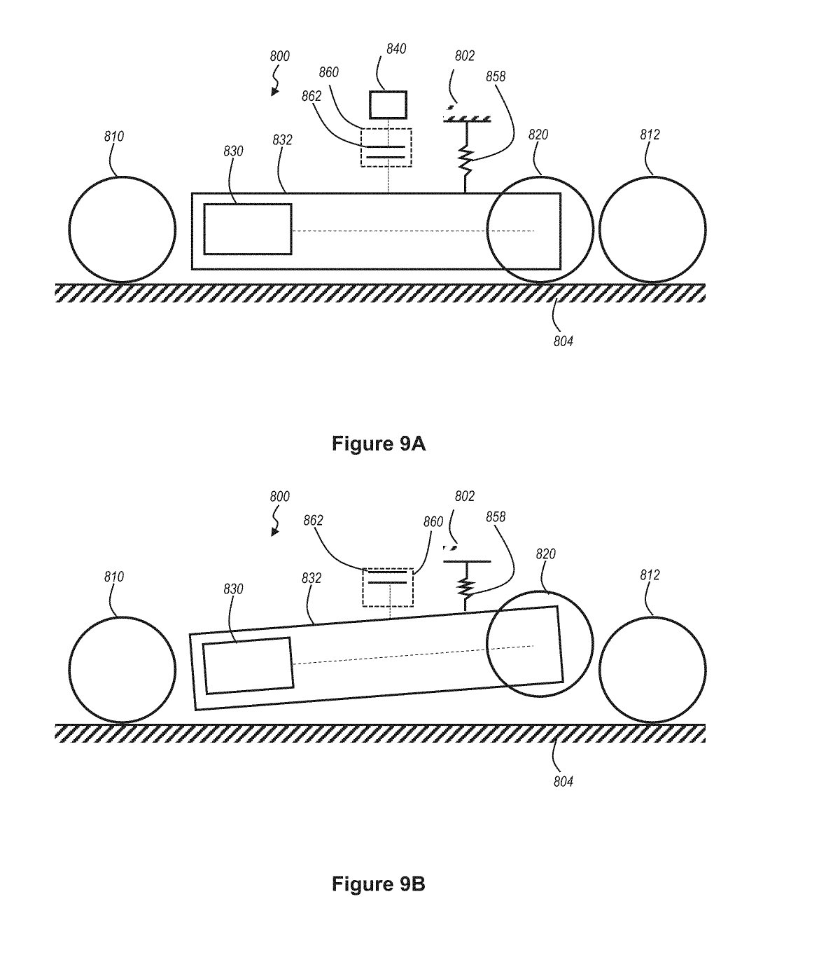

With reference next to FIGS. 9A-B, the scooter assembly 800 can include a chassis, a portion 802 of which is illustrated. The chassis can include structures and features which are similar to, or the same as, those of scooter 100 described in connection with FIG. 1. In some embodiments, the chassis 802 can include a deck, a neck portion, and/or a housing for internal components. For reference, a surface 804 on which the scooter assembly 800 can be used is also shown.

The scooter assembly 800 can include one or more non-driven wheels 810, 812 which can be positioned along the front and rear of the scooter assembly 800 respectively. The scooter assembly 800 can include one or more driven wheels 820. Although the one or more driven wheels 820 is shown between the front non-driven wheel 810 and rear non-driven wheel 812, it is to be understood that the driven wheel can be positioned forward of both non-driven wheels 810, 812, rearward of both non-driven wheels 810, 812, and/or in line with the front non-driven wheel 810 and/or rear non-driven wheel 812. Moreover, it is to be understood that the number of wheels can be chosen as desired based on the type of electric vehicle or toy such as, but not limited to, a two-wheeled scooter, a four-wheeled skateboard or trolley, and the like.

The one or more driven wheels 820 can be operatively coupled to a powertrain 830 which can provide power to operate the one or more driven wheels 820. The powertrain 830 can include structures and features similar to those of the embodiments described in connection with FIGS. 2-8B. For example, the powertrain 830 can include one or more motors (not shown) and/or a transmission system (not shown). In some embodiments, the transmission system includes components, structures and features similar to, or the same as, those described in connection with the solid-gear transmission 300 and/or the chain-drive transmission 500 described in connection with FIGS. 2-6.

The scooter assembly 800 can include one or more power sources 840, such as batteries, to provide energy for the powertrain 830. As shown in the illustrated embodiment, the powertrain 830 can include a housing 832. As shown in the illustrated embodiment, the entirety of the powertrain 830 can be included in the housing 832; however, it is to be understood that a portion of the powertrain 830 can be included in the housing 832. For example, a portion or the entirety of the transmission system can be included in the housing 832 and/or a portion or the entirety of the motor can be included in the housing 832.

With continued reference to FIGS. 9A-B, the scooter assembly 800 can include movable structures to couple and decouple the one or more driven wheels 820 with the surface 804 on which the scooter assembly 800 is being used. In the “coupled” state, the scooter assembly 800 can take on an “electric-power” configuration such that the user can utilize the one or more motors of the powertrain 830 to power the scooter assembly 800. In the “decoupled” state, the scooter assembly 800 can take on a “manual-power” configuration. This can significantly reduce resistance caused by the drive system (i.e., powertrain 830 and one or more driven wheels 820). As will be described in further detail below, in some embodiments, switching between the “coupled” and “decoupled” states can occur automatically when the one or more power sources 840 are removed from the scooter assembly 800.

As shown, the one or more driven wheels 820 can coupled to the housing 832. The housing 832 can be coupled to a portion of the chassis 802 via a biasing mechanism 858 such as a spring. In this manner, the housing 832 and the one or more driven wheels 820 can be biased in a direction away from the surface 804. The housing 832 can also be coupled to a mode-switching system 860 having one or more actuators 862. In a “coupled” state as shown in FIG. 9A, the one or more actuators 862 can apply a force on housing 832 which opposes that of the biasing mechanism 858. This can bring the one or more driven wheels 820 into contact with surface 804 such that the one or more driven wheels 820 can be used to propel the scooter assembly 800. In a “decoupled” state as shown in FIG. 9B, the one or more actuators 862 can apply a lesser force, or no force at all, on housing 832 thereby allowing the biasing mechanism 858 to pull the housing 832 upwards towards the portion 802 of the chassis. This can pull the one or more driven wheels 820 out of contact with surface 804 thereby eliminating, or at least significantly reducing, resistance, which would typically be caused by the one or more driven wheels 820 and components of the powertrain 830. For example, the resistance (e.g., friction) can be reduced by 5% to 50% (e.g., 5-10, 10-20, 20-30, 30-40, 40-50%, percentages between the foregoing, etc.), by 10% to 70%, greater than 70%, etc. relative to equivalent scooters that do not have such a resistance-reducing feature.

As shown in the illustrated embodiment, the mode-switching system 860 can be operatively coupled to the one or more power supplies 840. In some implementations, the mode-switching system 860 can switch to the “decoupled” state as shown in FIG. 9B when the one or more power supplies 840 are removed from the scooter assembly 800. The scooter assembly 800 can thereby automatically switch to a “manual-power” mode upon removal of the one or more power sources 840.

In some embodiments, the mode-switching system 860 can include a linkage or hydraulic system which operates the one or more actuators 862. The linkage or hydraulic system can be mechanically operated via positioning of the one or more power supplies 840. For example, the linkage or hydraulic system can transition the one or more actuators 862 to the “decoupled” state when the one or more power supplies 840 are removed from the scooter assembly 800. In some embodiments, the linkage or hydraulic system can be electronically actuated. For example, the scooter assembly 800 can include a controller which can detect removal of the one or more power sources 840 from the scooter assembly 800. Upon detection of removal, the controller can operate the linkage or hydraulic system to transition the one or more actuators 862 to the “decoupled” state. For example, the controller can operate a motor coupled to the linkage or hydraulic system.

In some implementations, the mode-switching system 860 can switch back to the “coupled” state as shown in FIG. 9A when the one or more power supplies 840 are replaced into the scooter assembly 800. The scooter assembly 800 can thereby automatically switch back to an “electric-power” mode upon replacement of the one or more power sources 840 to allow the user to utilize the powertrain 830 to operate the scooter assembly 800. The linkage or hydraulic system can be mechanically operated via positioning of the one or more power supplies 840. For example, the linkage or hydraulic system can transition the one or more actuators 862 to the “coupled” state when the one or more power supplies 840 are replaced into the scooter assembly 800. In some embodiments, the linkage or hydraulic system can be electronically actuated. For example, the scooter assembly 800 can include a controller which can detect replacement of the one or more power sources 840 into the scooter assembly 800. Upon detection of replacement, the controller can operate the linkage or hydraulic system to transition the one or more actuators 862 to the “coupled” state. For example, the controller can operate a motor coupled to the linkage or hydraulic system.

In some embodiments, such automatic switching between the “decoupled” and “coupled” state can facilitate operation of the scooter assembly 800 by the user. However, in some embodiments, switching between the “decoupled” and “coupled” state can be performed manually by the user when the one or more power sources 840 remain in the scooter assembly 800. For example, the linkage or hydraulic system can be operated by the user via a control such as, but not limited to, a lever, a knob, or a button mechanically or electronically coupled to the linkage or hydraulic system. This can beneficially allow the user to manually operate the scooter assembly 800 with reduced resistance while the one or more power sources 840 remain in the scooter assembly 800. For example, the user may wish to manually operate the scooter assembly 800 when the one or more power sources 840 have been depleted or if the user simply wants to conserve runtime of the power sources 840. In some embodiments, the mode-switching system 860 remains in the “decoupled” state until the one or more power sources 840 have been replaced.

Although actuators 862, linkages, and hydraulic systems have been described in the embodiments above, it is to be understood that one or more of these components can be omitted. For example, in some embodiments, the linkages and/or hydraulic systems can be omitted from the mode-switching systems 860. In such embodiments, the one or more power sources 840 can directly contact and operate the actuators 862. As another example, in some embodiments, actuators 862, linkages, and hydraulic systems can be omitted from the mode-switching systems 860. In such embodiments, the one or more power sources 840 can directly manipulate one or more components of the powertrain (e.g., the one or more motors and/or the transmission system). For example, the one or more power sources 840 can contact the housing 832 directly.

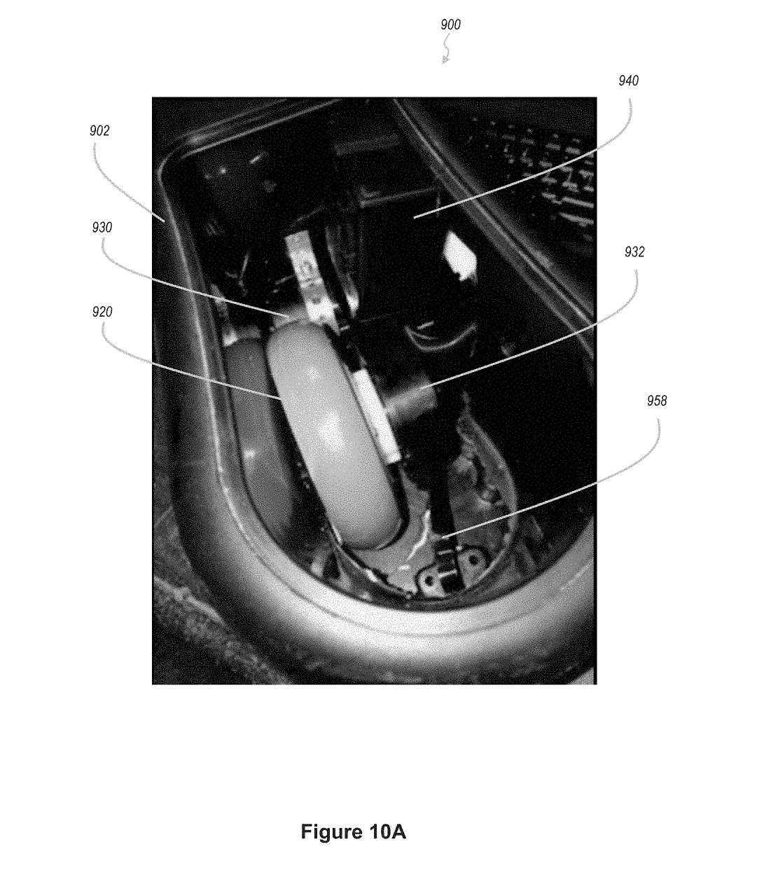

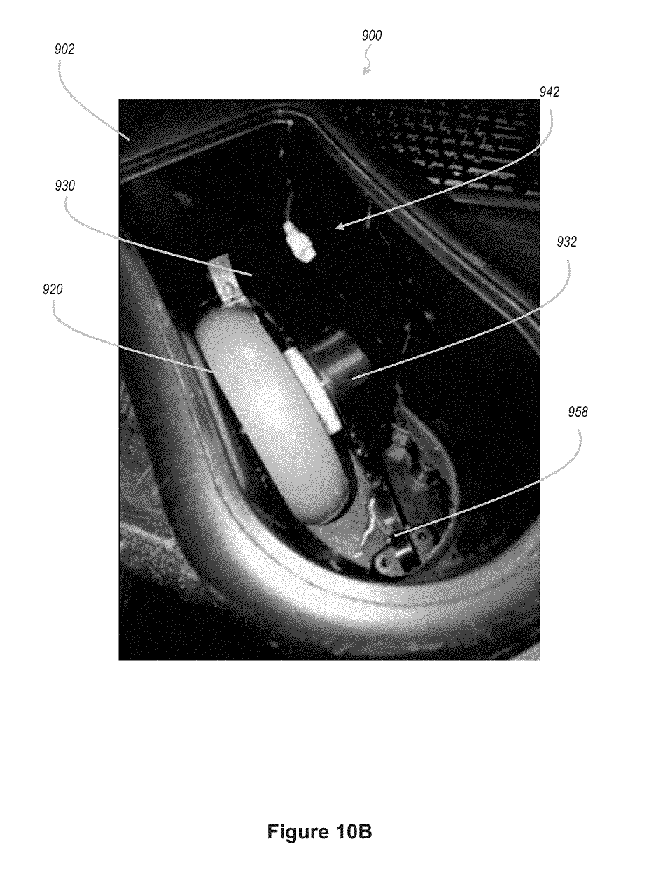

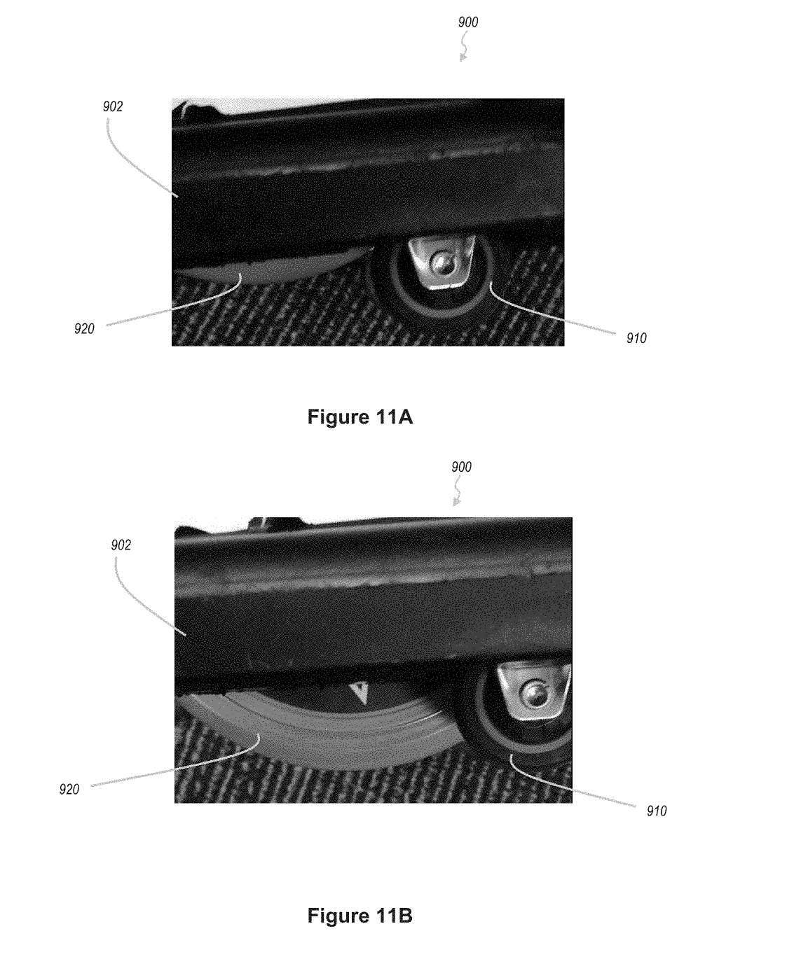

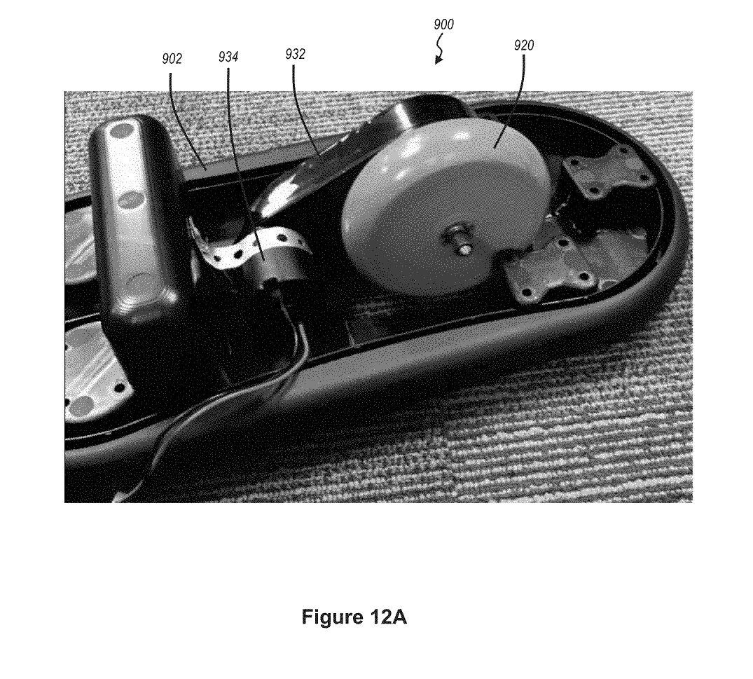

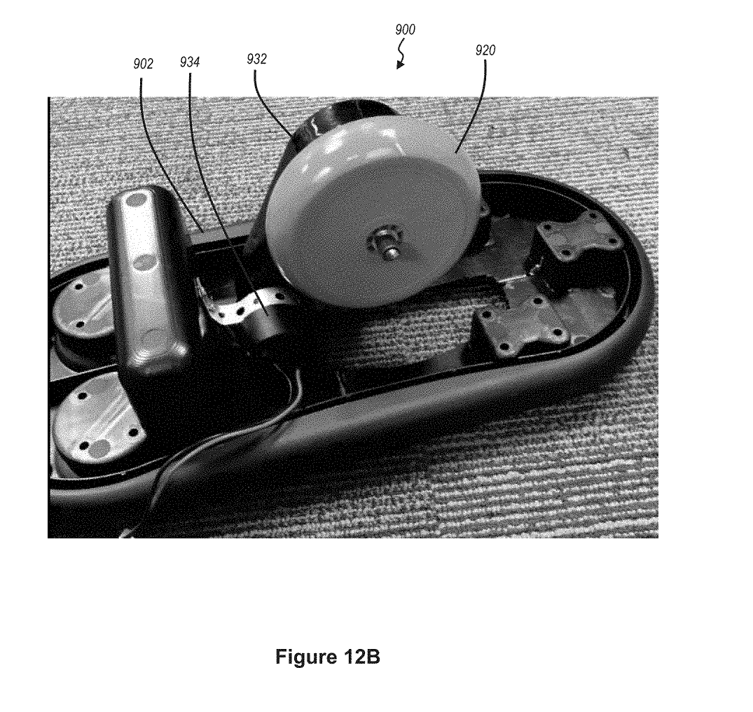

With reference next to FIGS. 10A-12B, an electric vehicle 900 can include a chassis, 902. The electric vehicle 900 can include one or more non-driven wheels 910 (shown in FIGS. 11A-B) which can be positioned along the front (not shown) and rear of the electric vehicle 900 respectively. The electric vehicle 900 can include a drive wheel 920. The driven wheel 920 can be operatively coupled to a powertrain 930 which can provide power to operate the driven wheel 920. The powertrain 930 can include structures and features similar to those of the embodiments described in connection with FIGS. 2-9B. For example, the powertrain 930 can include a motor 934 (shown in FIGS. 12A-B) and/or a transmission system (not shown). In some embodiments, the transmission system can include structures and features similar to, or the same as, those described in connection with the solid-gear transmission 300 and/or the chain-drive transmission 500 described in connection with FIGS. 2-6. The electric vehicle 900 can include a power source 940 in the form of a battery to provide energy for the powertrain 930. As shown in the illustrated embodiment, the powertrain 930 can include a housing 932. The housing 932 covers the transmission system and at least a portion of the motor 934.

The electric vehicle 900 can include movable structures to couple and decouple the one or more driven wheels 920 with the surface on which the electric vehicle 900 is being used. In the “coupled” state, the electric vehicle 900 can take on an “electric-power” configuration such that the user can utilize the motor 934 to power the electric vehicle 900. In some arrangements, in the “decoupled” state, the electric vehicle 900 can take on a “manual-power” configuration. This can significantly reduce resistance caused by the drive system (i.e., powertrain 930 and driven wheel 920). As will be described in further detail below, in some embodiments, switching between the “coupled” and “decoupled” states can occur automatically when the power source 940 is removed from the electric vehicle 900.

As shown, the driven wheel 920 can coupled to the housing 932. The housing 932 can be coupled to a portion of the chassis 902 via a biasing mechanism 958 such as a spring (e.g., a cantilever spring). In this manner, the housing 932 and the one or more driven wheels 920 can be biased in a direction away from the surface on which the electric vehicle 900 is to be used.

As shown in the illustrated embodiment, the electric vehicle can incorporate a mode-switching system. In a “coupled” state as shown in FIG. 10A, the power source 940 can apply a force on housing 932 which opposes that of the biasing mechanism 958. This can bring the one or more driven wheels 920 into contact with the surface such that the one or more driven wheels 920 can be used to propel the electric vehicle 900 (see FIG. 11B). In a “decoupled” state as shown in FIG. 10B, the power source 940 has been removed from a receptacle 942 thereby allowing the biasing mechanism 958 to push the housing 932 upwards away from the surface. This can pull or otherwise move the one or more driven wheels 920 out of contact with the surface thereby eliminating, or at least significantly reducing, resistance which would typically be caused by the one or more driven wheels 920 and components of the powertrain 930.

### Bearing Arrangements

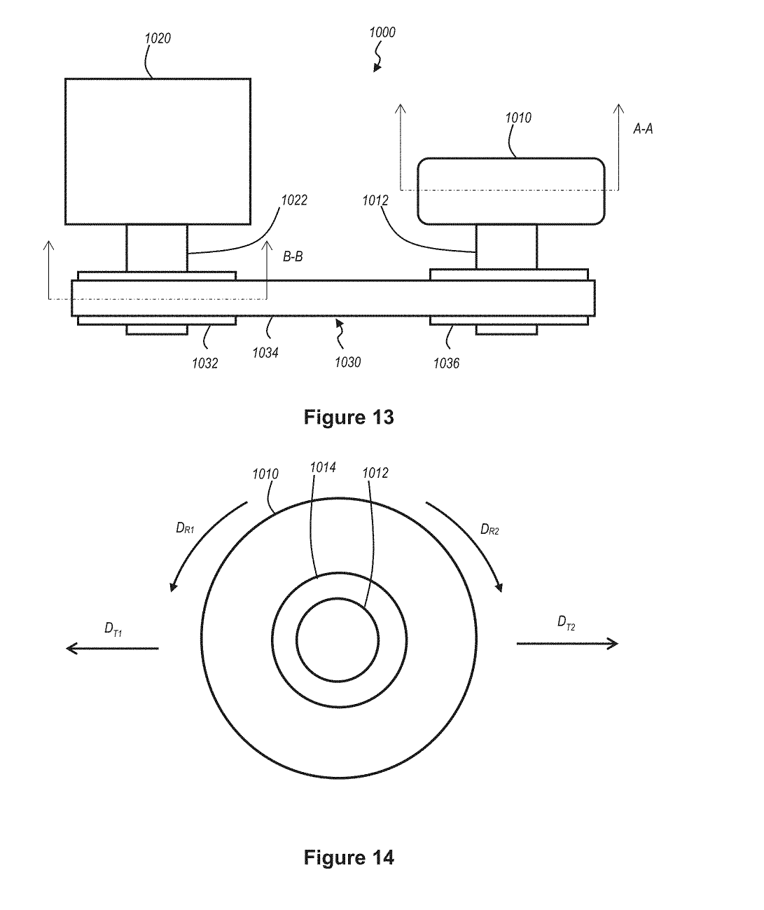

With reference next to FIGS. 13-15, embodiments of a drive system 1000 is illustrated schematically. The drive system 1000 can include structures and features similar to those of the embodiments described in connection with FIGS. 2-12B. The drive system 1000 can include one or more one-way bearings including, but not limited to, one-way needle bearings. The one-way bearings can beneficially enhance the efficiency of the drive system 1000. For example, the one-way bearings can reduce resistance while the scooter is moving without electric motor assistance. This can allow the user to beneficially manually operate the scooter with reduced resistance normally caused by components of the powertrain (e.g., the motor and/or transmission). This can also permit the scooter to “coast” over a longer distance. For example, the user may operate the electric motor to propel the scooter to a desired speed and discontinue use of the electric motor once the desired speed is reached.

With reference first to FIG. 13, a drive system 1000 is illustrated having a driven wheel 1010, a motor 1020, and a transmission system 1030. The driven wheels 1010 can include an axle 1012 about which the driven wheel 1010 can be rotated. The motor 1020 can include a motor shaft 1022 which can be rotated by the motor 1020. The transmission 1030 can include a first gear 1032, a chain 1034, and a second gear 1036. In some arrangements, the transmission 1030 transfers mechanical power output from the electric motor 1000 to the driven wheel 1010.

In some embodiments, the motor 1000 provides mechanical power to the motor shaft 1022. For example, when mechanical power is provided to the electric motor shaft 1022, it can rotate. The first gear 1032 can be coupled to the motor shaft 1022. The first gear 1032 can include teeth configured to engage links of the chain 1034. For instance, when the electric motor shaft 1022 rotates, rotational energy can be transferred to the chain 1034. The chain 1034 can impart its rotational energy to the second gear 1036. The second gear 1036 can impart its rotational energy to the axle 1012. For example, when the second gear 1036 rotates, the axle 1012 can rotate at the same rotational speed. The axle 1012 can be configured to engage the driven wheel 1010. For example, when the axle 1012 rotates, rotational energy can be transferred to the driven wheel 1010.

With reference next to FIG. 14, an embodiment of a driven wheel 1010 is illustrated schematically. The schematic is illustrated in cross-section along line A-A shown in FIG. 13. As shown, the driven wheel 1010 can include a one-way bearing 1014 positioned between the driven wheel 1010 and the axle 1012. The one-way bearing 1014 can allow the driven wheel 1010 to freely rotate in a desired direction while inhibiting or preventing rotation in an opposite direction. For example, in some embodiments, the one-way bearing 1014 can allow the driven wheel 1010 to rotate along direction D_{R1} while inhibiting or preventing rotation along direction D_{R2}. This can allow the driven wheel to freely rotate, without rotating the motor 1020 or transmission system 1030, when the scooter is moving in direction D_{T2} (e.g., a forward direction). This can allow the user to beneficially more easily operate the scooter manually. This can also allow the scooter to “coast” over a longer distance when the motor 1020 is not being used. Moreover, by inhibiting or preventing rotation along direction D_{R2}, the driven wheel 1010 can be rotated along direction D_{R1} when the axle is rotated along direction D_{R1} by the motor 1020.

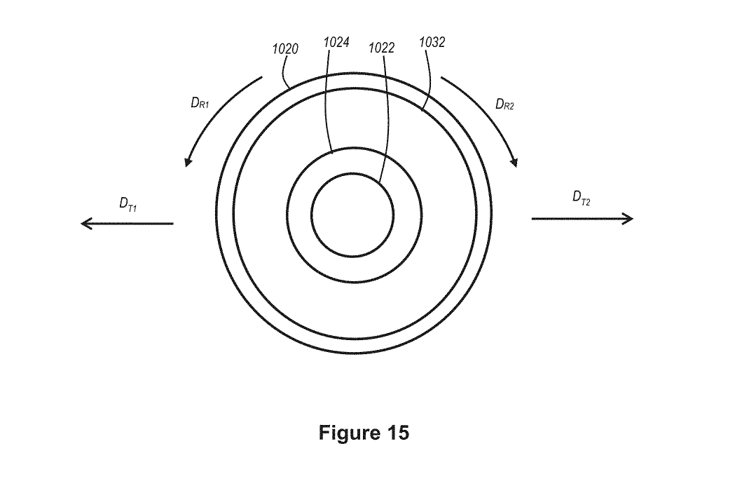

With reference next to FIG. 15, an embodiment of a motor 1020 is illustrated schematically. The schematic is illustrated in cross-section along line B-B shown in FIG. 13. As shown, the motor 1020 can include a one-way bearing 1024 positioned between the motor shaft 1022 and the first gear 1032. The one-way bearing 1024 can allow the first gear 1032 to freely rotate in a desired direction while inhibiting or preventing rotation in an opposite direction. For example, in some embodiments, the one-way bearing 1024 can allow the first gear 1032 to rotate along direction D_{R1} while inhibiting or preventing rotation along direction D_{R2}. This can allow the first gear 1032 to freely rotate, without rotating the motor 1020 and motor shaft 1022, when the scooter is moving in direction D_{T2} (e.g., a forward direction). Similar to the embodiment of driven wheel 1020 described in connection with FIG. 10, this can allow the user to beneficially more easily operate the scooter manually. This can also allow the scooter to “coast” over a longer distance when the motor 1020 is not being used. Moreover, by inhibiting or preventing rotation along direction D_{R2}, the first gear 1032 can be rotated along direction D_{R1} when the motor shaft 1022 is rotated along direction D_{R1} by the motor 1020.

In some embodiments, a single one-way bearing can be utilized such as the one-way bearing 1014 used with the driven wheel 1010 or the one-way bearing 1024 used with the motor 1020; however, it is to be understood that the multiple one-way bearings can be used. For example, both one-way bearings 1014, 1024 can be utilized in the drive system 1000. Moreover, it is to be understood that the one-way bearings 1014, 1024 can be used in any of the embodiments described herein. For example, one or both one-way bearings 1014, 1024 can be used in conjunction with the scooter assemblies 600a-c, 700, 800, 900 having mode-switching systems. It is to be understood that one-way bearings can be incorporated into any components within the drive system (e.g., motor, transmission system, and/or driven wheels). In embodiments with transmission systems, such as solid-gear transmission 300 and chain-drive transmission 500, a one-way bearing can be positioned in one or more of the transmission components such as, but not limited to, first gear 310, second gear 320, third gear 330, motor shaft 410, and/or gear 520 to allow the transmission components to freely rotate in one direction while inhibiting or preventing rotation in an opposite direction.

### On-Board Charging System

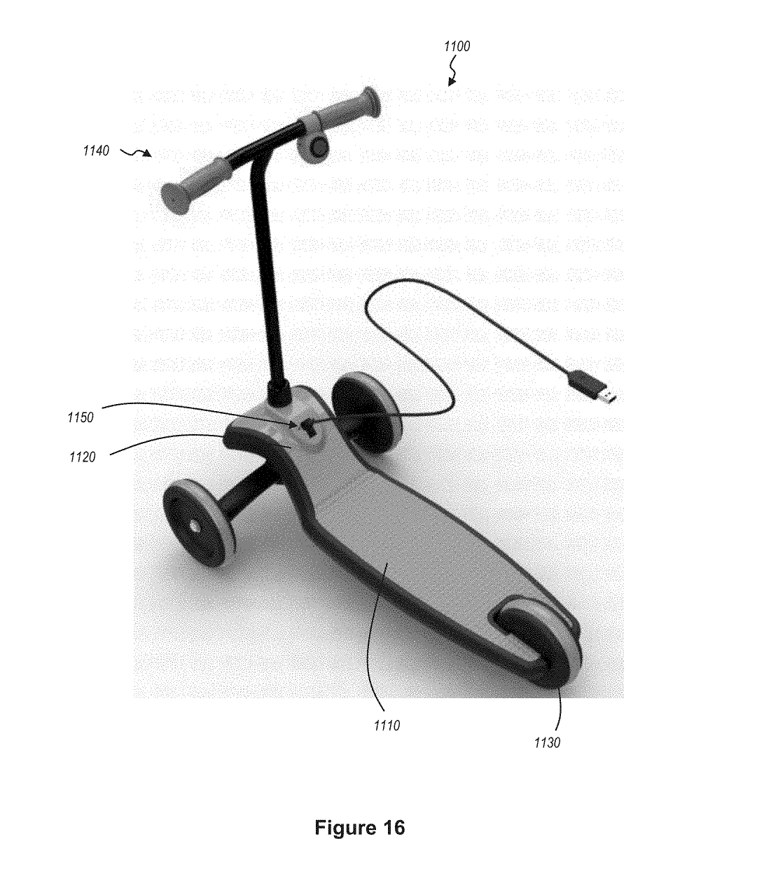

With reference next to FIGS. 16-18, embodiments of scooters 1100, 1300 having on-board charging systems are illustrated. The on-board charging system can significantly facilitate the process of charging the device and maintaining the device in a ready-to-use state. For example, since the electronics for charging the device are maintained on the scooters 1100, 1300 themselves rather than an external component, the scooters 1100, 1300 can be charged using a wider variety of charging devices in addition to wall chargers, such as car chargers and portable chargers. This can be particularly beneficial when a user is away from a standard wall socket.

With reference first to FIG. 16, the scooter 1100 can generally include a deck 1110, a neck portion 1120, a rear wheel 1130, and a steering assembly 1140. However, it is to be understood that the scooter 1100 can include other features similar to those of other scooters described herein. As shown in the illustrated embodiment, the scooter 1100 can include a port 1150. The port 1150 can be positioned on a component of the scooter 1100, such as the neck portion 1120 and/or the deck 1110. The port 1150 can electrically couple with one or more plugs such as, but not limited to, Universal Serial Bus (USB) (e.g., mini-USB, microUSB, type-C, etc.). The port 1150 can form part of an electronic system 1200.

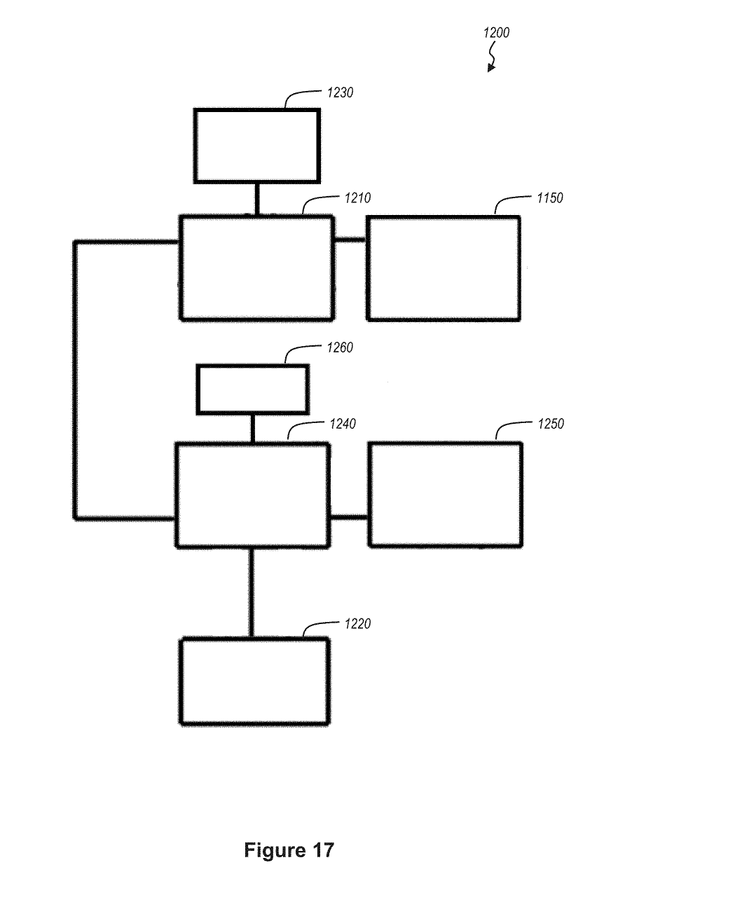

With reference next to FIG. 17, an embodiment of an electronic system 1200 is illustrated. The electronic system 1200 can include the port 1150 to connect the electronic system 1200 to another device, such as a USB charger. In some implementations, the port 1150 can receive an electronic current with a voltage between about 5V to about 20V and an amperage of between about 500 mA to about 5 A. For example, the port 1150 can receive an electronic current with a voltage of about 5V and an amperage of about 2 A.

The electronic system 1200 can include a circuit 1210 which can convert the voltage and/or amperage from the port 1150 into a voltage and/or amperage which is more suitable for other components of the electronic system 1200, such as a rechargeable battery 1220. In some implementations, the circuit 1210 can output an electronic current with a voltage between about 6V to about 24V (e.g., 6V, 7.2V, 12V, 24V) and an amperage of between about 100 mA to about 5 A. For example, the circuit 1150 can output an electronic current with a voltage of about 7.2V and an amperage of about 500 mA.

In some embodiments, the circuit 1210 can detect the voltage in the rechargeable battery 1220. The circuit 1210 can provide an indication of the charging status of the rechargeable battery 1220. For example, the circuit 1210 can send a signal to indicator 1230 when the rechargeable battery 1220 has reached a desired level of charge (e.g., the battery meets or exceeds a threshold voltage). In some implementations, the circuit 1210 can cease outputting any further electronic current once the rechargeable battery 1220 has reached a desired level of charge.

In some embodiments, the electronic system 1200 can include a controller 1240. The controller 1240 can be utilized to operate a motor 1250 based on an input on a user control 1260. For example, the controller 1240 can output a regulated amount of electronic current to the motor 1250. In some implementations, the controller 1240 can automatically cease outputting power upon detection of a plug being inserted into the port 1150. In some implementations, the controller 1240 can continue outputting power upon detection of a plug being inserted into the port 1150 to allow the user to utilize the scooter 1100 while the device is being charged. This can be particularly beneficial in situations where the scooter 1100 is attached to a portable charger.

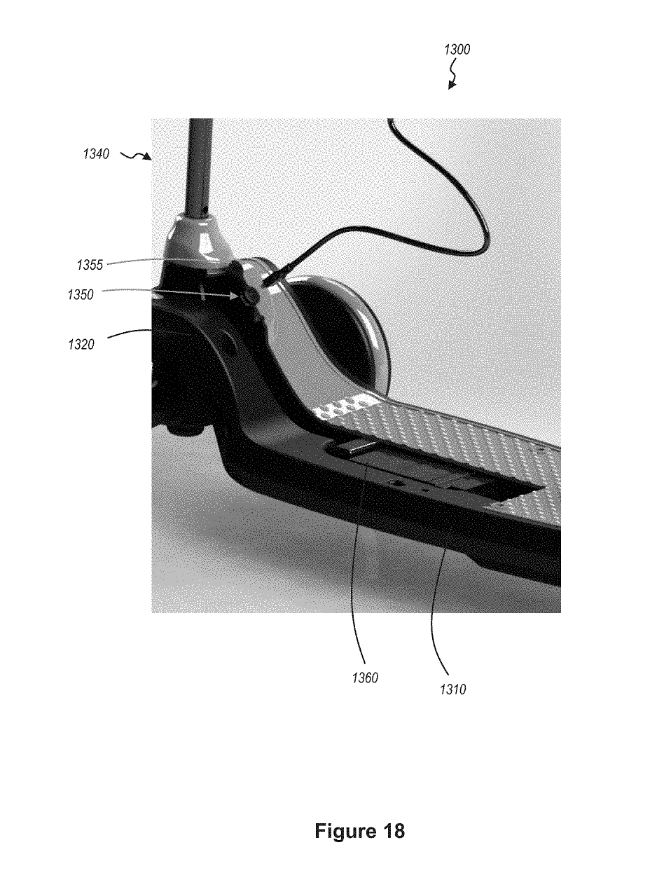

With reference next to FIG. 18, the scooter 1300 can generally include a deck 1310, a neck portion 1320, a rear wheel (not shown), and a steering assembly 1340. However, it is to be understood that the scooter 1300 can include other features similar to those of other scooters described herein. As shown in the illustrated embodiment, the scooter 1300 can include a port 1350. The port 1350 can be positioned on a component of the scooter 1300, such as the neck portion 1320 and/or the deck 1310. The port 1350 can electrically couple with one or more plugs such as, but not limited to, Universal Serial Bus (USB) (e.g., mini-USB, microUSB, type-C). As shown, the port 1350 can include a cap 1355 to cover the port 1350 when not in use.

The scooter 1300 can include electronics 1360 which can form part of the on-board charging system. For example, the electronics 1360 can include one or more components described in connection with electronic system 1200 such as, but not limited to, a power source and/or motor. As shown, the electronics 1360 can be positioned within the deck 1310 of the scooter 1300 to enhance weight distribution; however, it is to be understood that electronics can be positioned along other portions of the scooter 1300 such as, but not limited to, the neck portion 1320 and the steering assembly 1340.

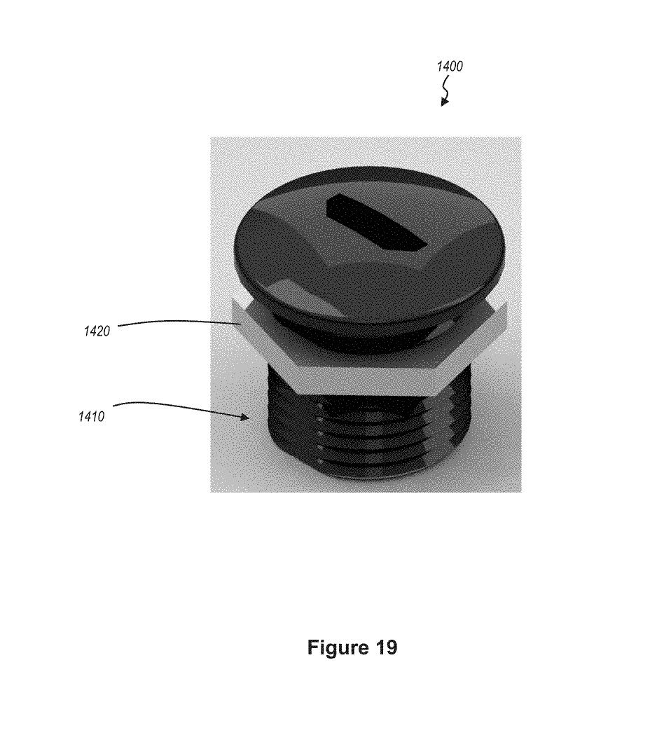

With reference next to FIG. 19, an embodiment of a port 1400 is illustrated. As shown, the port 1400 can be designed to receive a microUSB plug. The port 1400 can include a connector portion 1410 which can removably couple with a corresponding receiver 1420. For example, the connector portion 1410 and the receiver 1420 can include complementary threads. In some implementations, the receiver 1420 can be mounted directly to a portion of a scooter and the port 1400 can be removably coupled to the receiver 1420.

### Other Embodiments

While certain embodiments have been described, these embodiments have been presented by way of example only, and are not intended to limit the scope of the disclosure. Indeed, the novel systems and methods described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope of the disclosure. Accordingly, the scope of the present disclosure is defined only by reference to the claims presented herein or as presented in the future.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

1-56. (canceled)

57. An electric vehicle or toy having at least an electric-operation mode and manual-operation mode, the electric vehicle or toy comprising:
a first wheel;
a second wheel;
a powertrain comprising an electric motor;
a power source configured to provide power to the electric motor, the power source configured to be removable from the electric vehicle or toy; and
a mode-switching system configured to switch between at least the electric-operation mode and the manual-operation mode, wherein:
in the electric-operation mode, the electric motor is operably coupled to at least the first wheel; and
in the manual-operation mode, the electric motor is decoupled from at least the first wheel.

58. The electric vehicle or toy of claim 57, wherein the powertrain further comprises a transmission system having a first transmission component and a second transmission component.

59. The electric vehicle or toy of claim 58, wherein:
in the electric-operation mode, the electric motor is operably coupled to the transmission system; and
in the manual-operation mode, the electric motor is decoupled from the transmission system.

60. The electric vehicle or toy of claim 58, wherein:
in the electric-operation mode, the first transmission component is operably coupled to the second transmission component; and
in the manual-operation mode, the first transmission component is decoupled from the second transmission component.

61. The electric vehicle or toy of claim 58, wherein the first transmission component comprises a first gear and the second transmission component is a second gear.

62. The electric vehicle or toy of claim 61, wherein the transmission further comprises a belt or chain.

63. The electric vehicle or toy of claim 57, wherein:
in the electric-operation mode, the powertrain is operably coupled to at least the first wheel; and
in the manual-operation mode, the powertrain is decoupled from at least the first wheel.

64. The electric vehicle or toy of claim 57, wherein the mode-switching system is configured to switch to the manual-operation mode upon removal of the power source.

65. The electric vehicle or toy of claim 64, wherein the mode-switching system is configured to remain in the manual-operation mode while the power source is removed.

66. The electric vehicle or toy of claim 57, wherein the mode-switching system is configured to switch to the electric-operation mode upon replacement of the power source.

67. The electric vehicle or toy of claim 57, wherein the mode-switching system is configured to switch between the electric-operation mode and the manual-operation mode via a control.

68. An electric vehicle or toy having at least an electric-operation mode and manual-operation mode, the electric vehicle or toy comprising:
a first wheel;
a second wheel;
a powertrain comprising an electric motor;
a power source configured to provide power to the electric motor, the power source configured to be removable from the electric vehicle or toy; and
a mode-switching system configured to switch between at least the electric-operation mode and the manual-operation mode, the mode-switching system configured to switch between the modes based at least in part on the position of the power source, wherein:
in the electric-operation mode, the electric motor is operably coupled to at least the first wheel; and
in the manual-operation mode, the electric motor is decoupled from at least the first wheel.

69. The electric vehicle or toy of claim 68, wherein the powertrain further comprises a transmission system having a first transmission component and a second transmission component.

70. The electric vehicle or toy of claim 69, wherein:
in the electric-operation mode, the electric motor is operably coupled to the transmission system; and
in the manual-operation mode, the electric motor is decoupled from the transmission system.

71. The electric vehicle or toy of claim 69, wherein:
in the electric-operation mode, the first transmission component is operably coupled to the second transmission component; and
in the manual-operation mode, the first transmission component is decoupled from the second transmission component.

72. The electric vehicle or toy of claim 69, wherein the first transmission component comprises a first gear and the second transmission component is a second gear.

73. An electric vehicle or toy having at least an electric-operation mode and manual-operation mode, the electric vehicle or toy configured to be used on a ground surface, the electric vehicle or toy comprising:
a first wheel;
a second wheel;
a powertrain comprising an electric motor, the powertrain being operably coupled to at least the first wheel;
a power source configured to provide power to the electric motor, the power source configured to be removable from the electric vehicle or toy; and
a mode-switching system configured to switch between at least the electric-operation mode and the manual-operation mode, wherein:
in the electric-operation mode, at least the first wheel is configured to contact the ground surface; and
in the manual-operation mode, at least the first wheel is configured to retract away from the ground surface.

74. The electric vehicle or toy of claim 73, wherein the powertrain further comprises a transmission system having a first transmission component and a second transmission component.

75. The electric vehicle or toy of claim 74, wherein the first transmission component comprises a first gear and the second transmission component is a second gear.

76. The electric vehicle or toy of claim 73, wherein the mode-switching system is configured to switch to the manual-operation mode upon removal of the power source.
